(19) United States
(12) Patent Application Publication
(10) Pub. No.: US 2012/0098745 A1
(43) Pub. Date: Apr. 26, 2012

(54) SYSTEM AND METHOD FOR HIGHLIGHTING MULTIMEDIA PRESENTATION

(75) Inventor: PO-CHANG WANG, Tu-Cheng (TW)

(73) Assignee: HON HAI PRECISION INDUSTRY CO., LTD., Tu-Cheng (TW)

(21) Appl. No.: 13/167,710

(22) Filed: Jun. 24, 2011

(30) Foreign Application Priority Data
Oct. 25, 2010 (CN) 201010518189.5

(51) Int. Cl. G06F 3/033

(52) U.S. Cl. 345/158

(57) ABSTRACT

A projector includes an infrared camera. Projected infrared rays on a screen are detected and the projector calculate coordinates of a center point of a projection area of the infrared ray projected on the screen. The coordinates of the center point is transformed to coordinates of a pixel point on the screen corresponding to a resolution of a projection lens of the projector. The projector determines the pixel point on the screen according to the converted coordinates. A light source of the projector is controlled to highlight the pixel point on the screen.

### BACKGROUND

1. Technical Field

Embodiments of the present disclosure generally relate to multimedia presentation management, and more particularly to a system and method for highlighting a multimedia presentation.

2. Description of Related Art

A laser pointer is often used to highlight part of a multimedia presentation displayed on a screen. However, if a user operates the laser pointer carelessly, the laser rays may damage eyes of the audience of the multimedia presentation.

### BRIEF DESCRIPTION OF THE DRAWINGS

FIG. 1 is a block diagram of one embodiment of a projector comprising a highlighting system.

FIG. 2 is a block diagram of one embodiment of function modules of the highlighting system in FIG. 1.

FIG. 3 is a flowchart illustrating a method for highlighting a multimedia presentation.

FIG. 4 is a schematic diagram illustrating one embodiment of a display area on a screen.

FIG. 5 is a schematic diagram illustrating one embodiment of coordinates of a center point of a projection area of an infrared ray on a screen.

FIG. 6 is a schematic diagram illustrating one embodiment of converted coordinates of the center point.

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

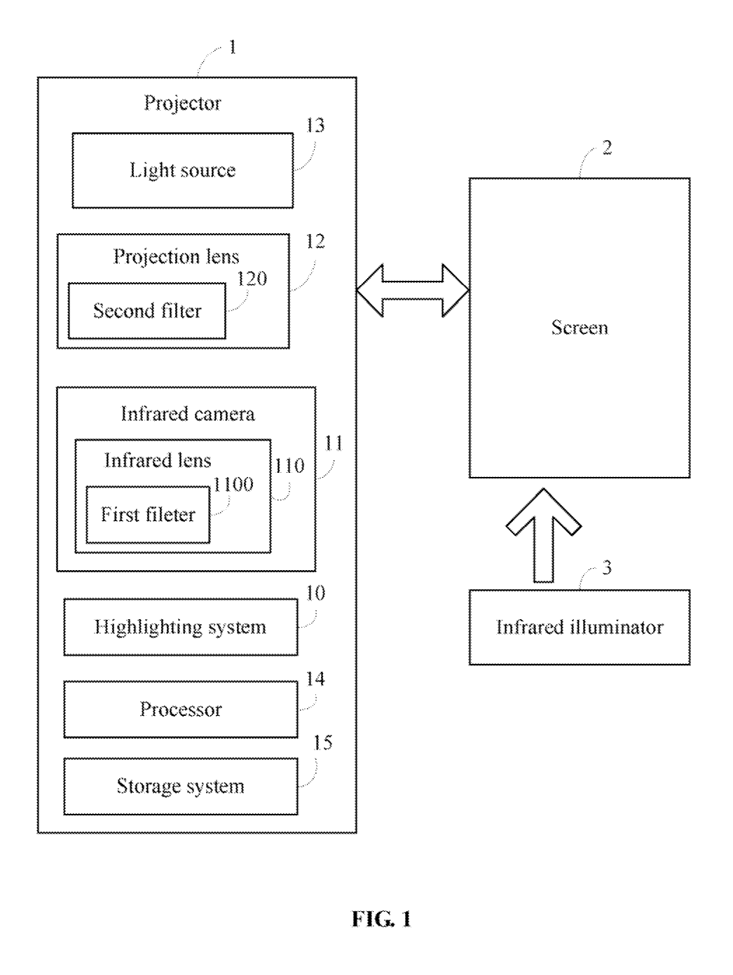

FIG. 1 is a block diagram of one embodiment of a projector 1. The projector 1 includes a highlighting system 10, an infrared camera 11, a projection lens 12, and a light source 13. The projecting lens 12 projects images to a screen 2.

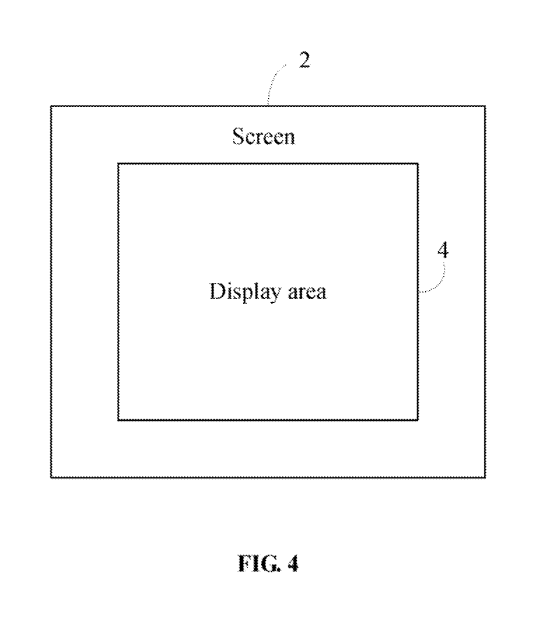

The infrared camera 11 is a camera that forms an image using infrared radiation. The infrared camera 11 includes a normal mode and an infrared mode. In the normal mode, the infrared camera captures images of a display area 4 (as shown in FIG. 4) between the infrared camera 11 and the screen 2. In some embodiments, the display area 4 is smaller than the screen 2. If the infrared camera 11 is in the infrared mode, the infrared camera 11 detects infrared rays on the screen. The infrared ray is projected by an infrared illuminator 3. In one embodiment, the infrared illuminator 3 may be held by a user who is doing a multimedia presentation.

The infrared camera 11 includes an infrared lens 110. A first filter 1110 is installed on the infrared lens 110. The first filter 1110 is used to control specific infrared rays which have specific wavelengths entering into the infrared lens 110. In one embodiment, the specific infrared rays may be projected by the infrared illuminator 3. The projecting lens 12 installs a second filter 120. The second filter 120 is used to protect infrared rays which has the same wavelengths as the infrared illuminator 3 from being projected onto the screen 2.

In an exemplary embodiment, the projector 1 includes at least one processor 14 and a storage system 15. The highlighting system 10 may include one or more modules. The one or more modules may comprise computerized code in the form of one or more programs that are stored in the storage system 15 (or memory). The computerized code includes instructions that are executed by the at least one processor 15 to provide functions for the one or more modules.

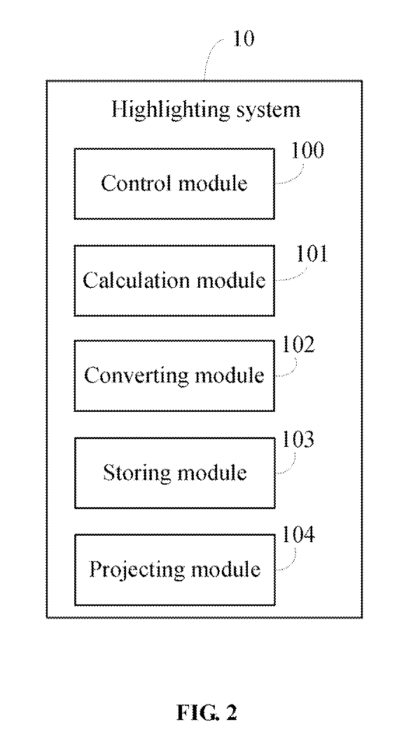

As shown in FIG. 2, the highlighting system 10 may include a control module 100, a calculation module 101, a converting module 102, a storing module 103, and a projecting module 104.

The control module 100 controls the infrared camera 11 to work in the normal mode. The infrared camera 11 captures images of the display area 4 on the screen 2. The control module 100 calculates a size of the display area 4. In one embodiment, the size of the display area 4 may be represented by a total number of pixel points distributed in the display area 4.

The control module 100 also controls the infrared camera 11 to work in the infrared mode. In the infrared mode, the infrared camera 11 detects if there are any infrared rays being projected on the screen 2. If an infrared ray is projected on the screen 2, the control module 100 calculates a size of a projection area of the infrared ray on the screen 2. In some embodiments, the projected area of the infrared ray on the screen 2 may be a circle or an ellipse.

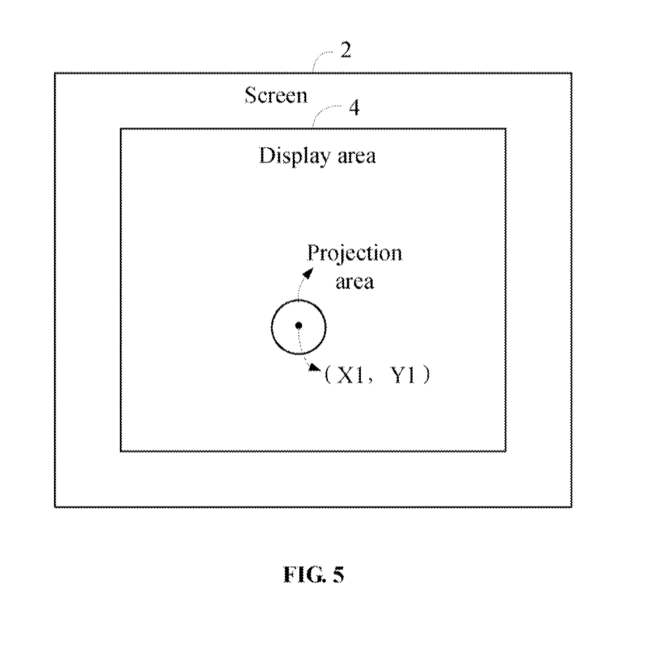

The calculation module 101 calculates coordinates of a center point of the projected area. As shown in FIG. 5, the coordinates (X1, Y1) are the coordinates of the center point of the projection area of the infrared ray on the screen 2.

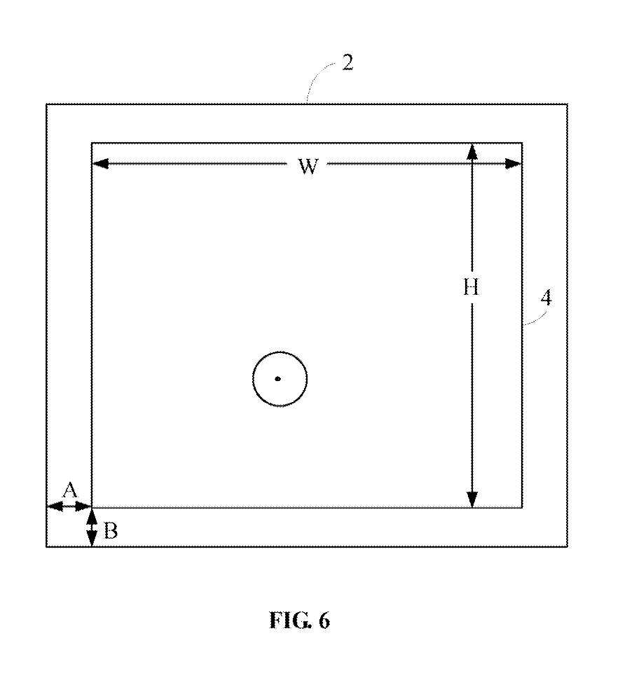

The converting module 102 converts the coordinates of the center point of the projection area to coordinates of a pixel point corresponding to a resolution of the projection lens 12 based on a conversion formula. For example, as shown in FIG. 6, the size of the display area 4 is W*H, namely there are W*H pixel points on the display area 4. In one embodiment, a vertex in lower left corner of the screen 2 is a reference origin (0, 0) and coordinates of a vertex in lower left corner of the display area 4 are (A, B). The resolution of the projection lens 12 is M*N. The conversion formula is “X2=[(X1−A/W)]*M, Y2=[(Y1−B)/H]*N.” The coordinates (X2, Y2) are coordinates of the center point of the projection area corresponding to the resolution of the projection lens 12.

The storing module 103 stores the converted coordinates, and determines the pixel point on the screen 2 according to the converted coordinates.

The projecting module 104 controls the light source 13 to highlight the pixel point on the screen 2. In one embodiment, the light source 13 projects light with high brightness to surrounding region of the pixel point on the display area 4 of the screen 2.

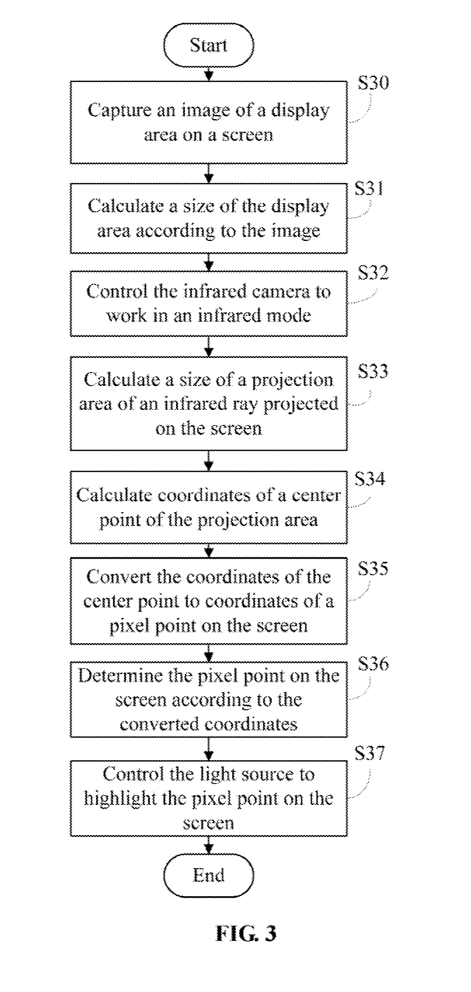

FIG. 3 is a flowchart illustrating a method for highlighting a multimedia presentation. Depending on the embodiment, additional blocks may be added, others removed, and the ordering of the blocks may be changed.

In block S30, the control module 100 controls the infrared camera 11 to work in the normal mode. The infrared camera 11 captures an image of the display area 4 on the screen 2.

In block S31, the control module 100 calculates a size of the display area 4 according to the image.

In block S32, the control module 100 controls the infrared camera 11 to work in the infrared mode. In the infrared mode, the infrared camera 11 detects if there are any infrared rays being projected on the screen 2.

In block S33, if there is an infrared ray being projected on the screen 2, the control module 100 calculates a size of a projection area of the infrared ray projected on the screen 2. In some embodiments, the projection area may be a circle or an ellipse.

In block S34, the calculation module 101 calculates coordinates of a center point of the projected area.

In block S35, the converting module 102 converts the coordinates of the center point of the projection area to coordinates of a pixel point corresponding to a resolution of the projection lens 12 based on a conversion formula.

In block S36, the storing module 103 stores the converted coordinates, and determines the pixel point on the screen according to the converted coordinates.

In block S37, the projecting module 104 controls the light source 13 to highlight the pixel point on the screen 2.

Although certain inventive embodiments of the present disclosure have been specifically described, the present disclosure is not to be construed as being limited thereto. Various changes or modifications may be made to the present disclosure beyond departing from the scope and spirit of the present disclosure.

What is claimed is:

1. A projector, comprising:
a storage system;
at least one processor; and
one or more programs being stored in the storage system and executable by the at least one processor, the one or more programs comprising:
a control module operable to control an infrared camera to detect infrared rays being projected on a screen;
a calculation module operable to calculate coordinates of a center point of a projection area of an infrared ray projected on the screen;
a converting module operable to convert the coordinates of the center point of the projection area to coordinates of a pixel point corresponding to a resolution of a projection lens of the projector;
a storing module operable to determine the pixel point on the screen according to the converted coordinates; and
a projecting module operable to control a light source to highlight the pixel point on the screen.

2. The projector as described in claim 1, wherein
the control module is further operable to control the infrared camera to capture a display area projected by the projector, and calculate a size of the display area; and
the control module is further operable to calculate a size of the projection area.

3. The projector as described in claim 2, wherein the converted coordinates are converted according to the size of the display area, the size of the projection area, and the resolution of the projector.

4. The projector as described in claim 1, wherein the infrared ray is projected by an infrared illuminator.

5. The projector as described in claim 1, wherein the infrared camera comprises an infrared lens being installed with a first filter which controls specific infrared rays which have specific wavelengths into the infrared lens.

6. The projector as described in claim 4, further comprising a projection lens being installed with a second filter which protects infrared rays which has the same wavelengths as the infrared illuminator from being projected onto the screen.

7. A method for highlighting a multimedia presentation, comprising:
controlling an infrared camera to detect infrared rays being projected on a screen;
calculating coordinates of a center point of a projection area of an infrared ray projected on the screen;
converting the coordinates of the center point of the projection area to coordinates of a pixel point corresponding to a resolution of a projection lens of the projector;
determining the pixel point on the screen according to the converted coordinates; and
controlling a light source to highlight the pixel point on the screen.

8. The method as described in claim 7, further comprising:
controlling the infrared camera to capture a display area projected by the projector and calculating a size of the display area if the infrared camera works in a normal mode; and
calculating a size of the projection area if the infrared camera works in an infrared mode.

9. The method as described in claim 8, wherein the converted coordinates are converted according to the size of the display area, the size of the projection area, and the resolution of the projector.

10. The method as described in claim 7, wherein the infrared ray is projected by an infrared illuminator.

11. A non-transitory storage medium having stored thereon instructions that, when executed by a processor, cause the processor to perform a method for highlighting a multimedia presentation, comprising:
controlling an infrared camera to detect infrared rays being projected on a screen;
calculating coordinates of a center point of a projection area of an infrared ray projected on the screen;
converting the coordinates of the center point of the projection area to coordinates of a pixel point corresponding to a resolution of a projection lens of the projector;
determining the pixel point on the screen according to the converted coordinates; and
controlling a light source to highlight the pixel point on the screen.

12. The non-transitory storage medium as described in claim 11, further comprising:
controlling the infrared camera to capture a display area projected by the projector and calculating a size of the display area if the infrared camera works in a normal mode; and
calculating a size of the projection area if the infrared camera works in an infrared mode.

13. The non-transitory storage medium as described in claim 12, wherein the converted coordinates are converted according to the size of the display area, the size of the projection area, and the resolution of the projector.

14. The non-transitory storage medium as described in claim 11, wherein the infrared ray is projected by an infrared illuminator.
